(19) United States
(12) Patent Application Publication
(10) Pub. No.: US 2006/0075441 A1
(43) Pub. Date: Apr. 6, 2006

(54) Method and system for a personal video recorder comprising multiple removable storage/tuner units

(75) Inventors: Ravi Gauba, Fremont, CA (US); Curtis Ray Eubanks, Lakewood, CO (US); Klaus Hofrichter, Santa Clara, CA (US); Annie Wang, San Jose, CA (US); Clement Lau, Los Altos, CA (US); Joseph Alexander Dara-Abrams, Los Altos, CA (US)

Correspondence Address: Jonathan O. Owens;HAVERSTOCK & OWENS LLP, 162 North Wolfe Road, Sunnyvale, CA, 94086, US

(73) Assignees: Sony Corporation; Sony Electronics Inc.

(21) Appl. No.: 10/960,206

(22) Filed: Oct. 6, 2004

(51) Int. Cl. H04N 7/16; H04N 5/445; H04N 7/173

(52) U.S. Cl. 725/89; 725/9; 725/42; 725/134

(57) ABSTRACT

A personal video recorder (PVR) enables delivery of audio-visual content and associated metadata to storage devices. The PVR is configured to access a plurality of services using a plurality of storage modules. Each storage module is dedicated to a single designated content provider. One or more of the storage modules are removably coupled to the PVR. A disconnected storage module can be reconnected to another PVR different from the PVR from which the storage module was disconnected. Where authorization is required to access content stored on the storage module, authentication is performed each time the removable storage module is reconnected to a PVR.

### FIELD OF INVENTION

The present invention relates to the field of personal video recorders. More particularly, the present invention relates to the field of personal video recorders comprising multiple removable storage/tuner units.

### BACKGROUND

The Personal Video Recorder (PVR) has in recent years become a popular alternative to VCRs because it allows random access to content and simplified management of recorded content. However, the current generation of PVRs allow only limited customization based on user preferences, and do not support multiple service providers.

Commercial systems exist that instruct the recording machine to record specific programs at known times and from known broadcast channels. Two such commercial systems currently used are the ReplayTV system manufactured by ReplayTV, Inc., of Mountain View, Calif. and the TiVo system manufactured by TiVo, Inc. of Sunnyvale, Calif. These systems typically use one or more transmission channels (e.g., telephone lines), different from the channels used to broadcast video programs, to receive codes that identify the time and broadcast channel of viewer-designated programs. The systems then record the identified programs for later output to the viewer. Both the TiVo and ReplayTV systems allow transfer of content between PVRs of the same type, however, the content is transferred over a local network connecting the systems and the service subscriber for each of the PVRs must be the same to provide necessary authorization.

Management of the storage space used by such recording devices is typically performed by the user. In some circumstances, a small portion of the storage space is managed by the system provider, such as TiVo or ReplayTV. For example, a small portion of the storage space is dedicated for “showcasing”, which is managed by the system provider for a third party desiring to place specific content, such as an advertisement, in the small portion of storage space.

Current PVR configurations include one or two tuners for decoding received content from a single service provider, such as a cable or satellite service provider, and a single storage unit, typically a disk drive, to store the content. Managing the storage and use of the content is substantially performed by the user.

Conventional PVRs show some level of automatic content management. For example, old content is automatically overwritten with new content once the storage capacity is reached. The TiVo system does provide automatic content acquisition not explicitly requested by the user, but which may be a match for the user based on previously watched content or a rating system. However, neither the TiVo system not the Replay TV system provides editorial content management by the service provider, other than the limited case of a reserved “showcase” area within the system. Without editorial content management, the service provider can not selectively remove or replace content.

Additionally, current personal video recorders allow only limited movement of storage media from one PVR to another, as discussed above. Furthermore, most PVRs on the market today do not handle content that requires authentication. As PVRs become more prevalent, and as standards mature, PVRs will begin to add additional value to consumers by offering premium content that is not available on free-to-air television. In a PVR system that stores content on removable media, content that requires authentication, for example content that the viewer must pay for, must be re-authenticated when the content moves from one PVR to another.

### SUMMARY

A system to provide content, includes a plurality of content sources, each content source providing one or more content data, and a controller apparatus including a plurality of storage modules, each storage module dedicated to a select one of the plurality of content sources. The controller apparatus can include a control device. The control device can be external to the plurality of storage modules. The control apparatus can be an integrated device including the control device and the plurality of storage modules. Each content data can include associated content metadata. The metadata can be provided by one or more metadata sources. One or more of the plurality of content sources can be a metadata source. One or more of the plurality of content sources are not a metadata source. Each storage module can receive content data independent of each of the plurality of storage modules. More than one of the plurality of storage modules can concurrently receive content data. Each storage module can include a receiver and a storage medium. Content data can be multimedia data. The controller apparatus can be coupled to one or more network connections to receive the one or more content data and associated metadata. Each of the one or more network connections can consist of a terrestrial, satellite, cable, or internet network connection. One of the one or more network connections can be a broadcast network. One of the one or more network connections can be a two-way network. The system can also include an output device coupled to the controller apparatus to receive and output content data. The controller apparatus can include a content manager to acquire content data based on associated metadata and stored user preferences. The content manager can enforce rights management rules.

A personal video recorder to receive content data includes a plurality of storage modules, each storage module to receive content data from a select one of a plurality of content sources and a control device coupled to the plurality of storage modules to control receiving and outputting of the content data to and from the personal video recorder. Each of the plurality of storage modules can be removed from the personal video recorder. The control device and the plurality of storage modules can be configured as an integrated device. Each content data can include associated content metadata. Each storage module can receive content data independent of each of the plurality of storage modules. More than one of the plurality of storage modules can concurrently receive content data. Each storage module can include a receiver and a storage medium. Content data can be multimedia data. The personal video recorder can also include one or more network connection ports to couple to one or more network connections to receive the content data and associated metadata. Each of the one or more network connections can consist of a terrestrial, satellite, cable, or internet network connection. One of the one or more network connections can be a broadcast network. One of the one or more network connections can be a two-way network. The personal video recorder can also include an output port to provide content data to an output device. The personal video recorder can also include a content manager to acquire content data based on associated metadata and stored user preferences. The content manager can enforce rights management rules.

A method of providing content data includes providing a recording apparatus including a plurality of storage modules, dedicating each one of the plurality of storage modules to receive content data from a select one of a plurality of content sources, and receiving content data by one of the plurality of storage devices from the select one content source. The method can also include associating metadata to each content data. The method can also include controlling management of each one of the plurality of storage modules by the select one of the plurality of content sources. The method can also include determining specific content data sent to one of the plurality of storage modules by the select one of the plurality of content sources. Determining specific content data can utilize predefined user preferences and the metadata. The method can also include concurrently receiving content data by more than one of the plurality of storage devices. The method can also include outputting content data from one of the plurality of content sources to an output device.

### BRIEF DESCRIPTION OF THE DRAWINGS

FIG. 1 illustrates a block diagram of a system environment including a personal video recorder.

FIG. 2 illustrates the personal video recorder connected to a plurality of external storage modules.

FIG. 3 illustrates a block diagram of the single storage module.

FIG. 4 illustrates an exemplary internal configuration of the personal video recorder.

FIG. 5 illustrates a method of receiving content utilizing the personal video recorder as implemented within the system of FIG. 1.

FIG. 6 illustrates a block diagram of a system used for authenticating content when the content stored on a removable media is moved from one PVR to another PVR.

FIG. 7 illustrates an example of information about content that is stored on the removable storage module.

FIG. 8 illustrates a method of authenticating content on a removable storage module when the removable storage module is moved from one PVR to another PVR.

### DETAILED DESCRIPTION

Embodiments of a personal video recorder (PVR) are directed to a hardware and software system for the delivery of audio-visual content and associated metadata to storage devices. The PVR is configured to access a plurality of services using a plurality of storage modules. Each storage module is dedicated to a single designated content provider. Content provided by multiple content providers can be bundled and distributed by a single service provider, such as a cable or satellite service provider. Alternatively, a content provider can provide content independent of other content providers, or a service provider can provide distribution of a single content source.

In a first embodiment, the plurality of storage modules are integrated within the PVR to form an integrated device. In a second embodiment, one or more of the plurality of storage modules are removably coupled to the PVR such that each removably coupled storage module can be disconnected from the PVR. In this second embodiment, the detached storage module can be reconnected to another PVR different from the PVR from which the storage module was detached. Where authorization is required to access content stored on the storage module, authentication is performed each time the removable storage module is reconnected to a PVR.

A plurality of users can be registered with each PVR, each of whom has one or more associated set of user preferences. Each user is uniquely identified by a user ID.

The personal video recorder is best described while considering the accompanying drawings below. Common elements maintain their references numerals throughout the Figures.

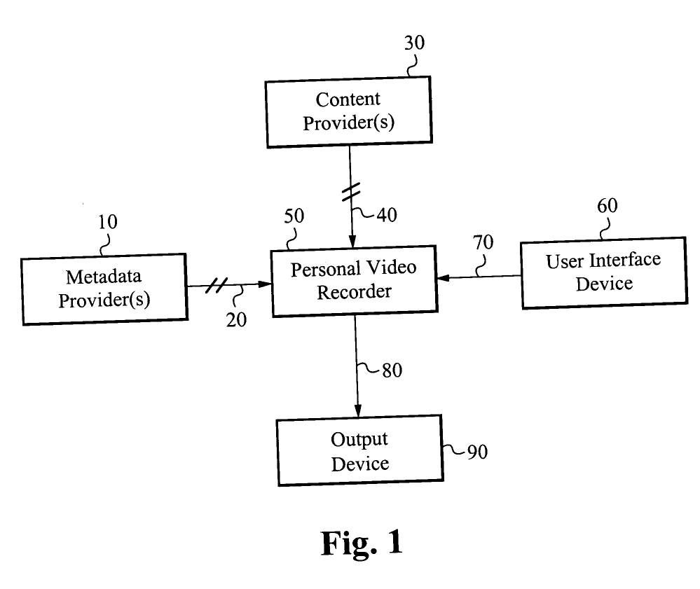

FIG. 1 illustrates a block diagram of a system environment including a personal video recorder 50. The system includes the PVR 50, a plurality of metadata providers 10, a plurality of content providers 30, a user interface device 60, and an output device 90. The plurality of metadata providers 10 use a plurality of network connections 20 to provide descriptive information (metadata) about multimedia content to personal video recorder 50. The plurality of content providers 30 use a plurality of network connections 40 to send multimedia content to the personal video recorder 50. Examples of network connections 20 and 40 include terrestrial, satellite, cable and Internet broadcasts networks. In some cases, one or more content providers 30 and one or more metadata providers 10 are the same entity.

In an alternative embodiment, the plurality of metadata providers 10 use a single common network connection 20. Similarly, the plurality of content providers 30 can share a common network connection 40. In the case where the plurality of network connections 20 and 40 each represent a single connection, the network connection 20 is the same network connection as the network connection 40, for example, a terrestrial television broadcast channel.

Personal video recorder 50 stores content from the plurality of content providers 30 and stores metadata from the plurality of metadata providers 10. Metadata is associated with specific content items, as is well known in the art. Personal video recorder 50 also outputs content to output device 90 over audio-video connection 80. For example, connection 80 is a set of analog audio and video cables, or an IEEE 1394 (i.LINK) digital connection. Examples of output device 90 include, but are not limited to, a video terminal such as a monitor or television, and an audio output device such as an audio amplifier and speakers. Personal video recorder 50 receives input from user interface device 60 over connection 70. An exemplary user interface device 60 is a remote controller, which typically uses an infrared protocol to connect to personal video recorder 50.

Although FIG. 1 illustrates the PVR 50 coupled to a plurality of content providers 30, the PVR 50 can also be coupled to a plurality of service providers. Each service provider can provide content originated from one or more content providers.

Each PVR 50 includes one or more storage modules, each storage module dedicated to store content provided by a single content provider. In the case where a service provider provides a single content source, the storage module is dedicated to the service provider.

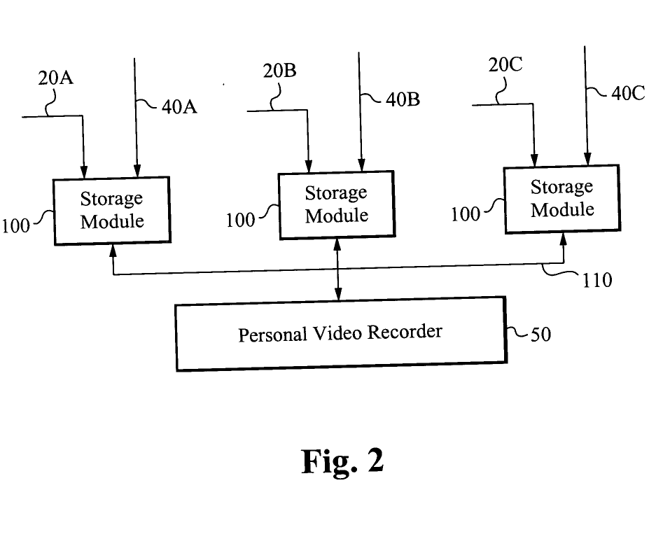

The PVR 50 supports a plurality of services, each service utilizing a separate storage module. FIG. 2 illustrates the PVR 50 connected to a plurality of external storage modules 100 via a bus 110. Each storage module 100 is a non-volatile, recordable storage device that is capable of storing and retrieving A/V content and metadata. Typically, each storage module 100 is a hard disk or flash-memory storage unit. Each storage module 100 is connected to a content network connection 40 and a metadata network connection 20. As illustrated in FIG. 2, each storage module 100 is independently coupled to a content network connection 40a, 40b, 40c and to a metadata network connection 20a, 20b, 20c. Alternatively, each content network connection 40a, 40b, and 40c are the same connection. Still alternatively, each metadata network connection 20a, 20b, and 20c are the same connection. In an alternative embodiment, each of the storage modules 100 are integrated within the PVR 50. In this alternative embodiment, the integrated storage modules 100 can either be removable or permanent.

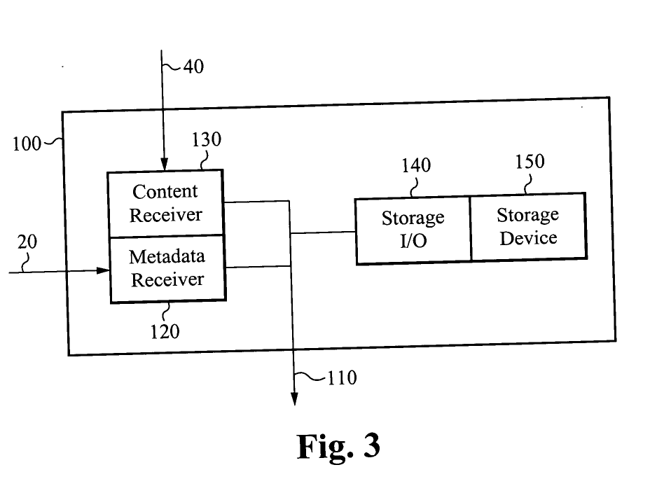

FIG. 3 illustrates a block diagram of the single storage module 100. Metadata receiver 120 receives metadata from the metadata network connection 20. An example of a metadata receiver is an MPEG-2 decoder that retrieves data embedded into a broadcast MPEG-2 stream. Content receiver 130 receives content from content network connection 40. An example of a content receiver is a digital television tuner. Receivers 120 and 130 are connected to bus 110 from which each receives data and control commands, output data, and status information.

Storage I/O controller 140 receives and executes commands to read and write to storage device 150. An example of a storage I/O controller is a SCSI controller or IDE hard disk drive controller. Storage device 150 is the physical storage device, such as a hard disk drive or a flash memory unit. Those skilled in the art will recognize that bus 110 can equivalently be substituted by a plurality of busses, for example, a PCI bus to control receivers 120 and 130, and a high speed bus, such as an IEEE1394 (i.LINK) serial bus, to send and receive data and commands from storage I/O controller 140.

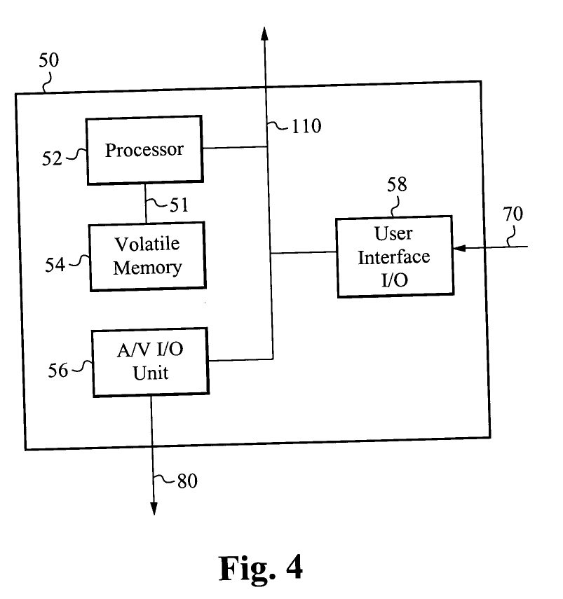

FIG. 4 illustrates an exemplary internal configuration of the PVR 50. The PVR 50 includes a processor 52, a volatile memory 54, an audio/video input/output unit 56, and a user interface input/output 58. The processor 52 receives data and commands from the common bus 110 and a high-speed memory bus 51, executes commands, and outputs data to busses 110 and 51. Processor 52 uses the high-speed memory bus 51 to connect to volatile memory 54. Volatile memory 54 is used to temporarily store data and commands. Also connected to bus 110 is user interface I/O 58 and A/V I/O interface unit 56.

A/V I/O interface unit 56 is used to control video and/or audio output of PVR 50. Separate I/O controllers for audio and video content can be substituted for a single controller with equivalent results. In FIG. 4, processor 52 sends commands and data to output audio/video content to A/V output controller 56 over bus 110. Alternatively, one or more separate busses can be used instead of a common bus to reduce traffic on common bus 110. For example, an Accelerated Graphics Port (AGP) bus is often used for the output of video data and control data. Volatile memory 54 is used to store temporary data and program commands used by processor 52. User interface I/O unit 58 is used to receive input from user interface connection 70 and to communicate these commands to processor 52. An example of a user interface I/O unit is a serial infrared remote controller.

The PVR 50 is also configured with software components to construct a highly personalized presentation of stored A/V content in accordance with a user's profile and viewing habits. The PVR 50 utilizes a Cache Manager, a Content Manager, a Profile Manager, a ShowFlow Manager, and a Presentation Manager.

The Cache Manager manages raw data as it is received in the storage modules, including acquisition of content from the content providers and metadata providers, and also removes invalid data. The Cache Manager supports data that has been pushed by the content provider, as well as data that has been “pulled” by the user, such as content requested by the user via a two-way network such as the Internet. In this manner content can be provided to the PVR either by the content provider or requested by the user.

The Content Manager manages content once it is stored in the storage modules. The Content Manager decides what content will be acquired based on metadata associated with the content and based on user preferences. The Content Manager further manages the validity of stored content. It will, for example, enforce rights management rules that are part of the metadata associated with a piece of content. For example, the rights management rules for a movie may specify that the movie must be deleted (or become inaccessible) after the consumer has viewed it once (or after a certain time period). The Cache Manager informs the Content Manager whenever new raw data is available (content or metadata). It is the responsibility of the Content Manager to maintain a list of valid content that is available to users for consumption.

The Profile Manager manages explicit and implicit preferences for users of the personal video recorder. Explicit preferences are those preferences that are explicitly set by the user, such as favorite actors or television show genres. Some explicit preferences may be specific to a single service, such as genre ratings. Other explicit preferences, such as favorite colors, preferred font type, and size for menus, are common to all services. Implicit preferences are those preferences that are learned by the PVR as a result of analyzing the viewing patterns of users. The Profile Manager coordinates with the Presentation Manager to create implicit preferences. Implicit preferences are service-specific, or in other words, implicit references are determined for and associated with specific associated content providers.

The ShowFlow Manager coordinates with the Content Manager to discover what content is available, and then consults the Profile Manager to order the content in a sequence that is tailored according to the user's preferences. The ShowFlow Manager recognizes triggers, pieces of metadata inserted by the metadata provider that cause certain content to be included in a playlist regardless of consumer preference. For example, a content provider might use triggers to play a series of advertisements in a particular order, even if the user's preferences would normally have played those advertisements back in a different order.

The PVR implements a “base ShowFlow Manager” to manage the playback and ordering of content for all services. As used herein, each “service” refers to content provided by each dedicated content provider associated with the storage modules within the PVR. For example, the base ShowFlow Manager maintains a “master” table of contents that is the union of the content available from all services. Each service also has a ShowFlow Manager that manages playlists for just that service. The base ShowFlow Manager works together with each individual service ShowFlow Manager when a user wishes to access content from more than one service. Operation of the ShowFlow Manager is described in greater detail in the U.S. patent application Publication 2002/0170068, filed Mar. 19, 2001, and entitled “Virtual and Condensed Television Programs”, which is also hereby incorporated in its entirety by reference.

The Presentation Manager manages display real estate and rendering of A/V content and non-content graphical elements. The ShowFlow Manager instructs the Presentation Manager what to display and how it should be displayed. This is done by either creating a presentation script that contains detailed instructions on what to display, or the ShowFlow Manager can alternatively simply pass a handle to the metadata of the content, or asset to be displayed, and let the Presentation Manager decide how to display it. The Presentation Manager maintains the display hardware's capabilities and is therefore uniquely qualified to render content based on this information.

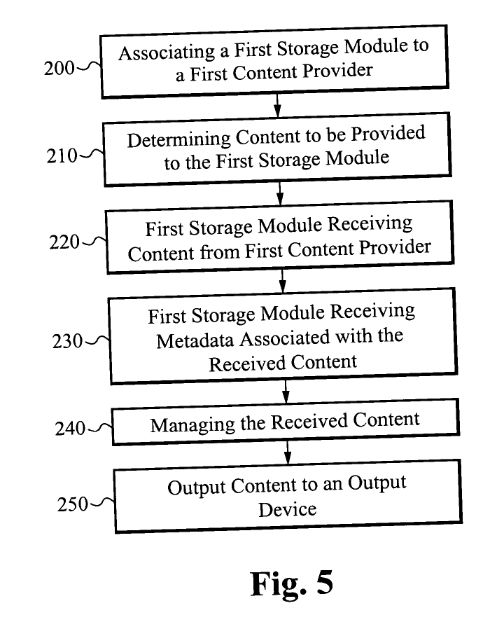

FIG. 5 illustrates a method of receiving content utilizing the personal video recorder as implemented within the system of FIG. 1. In the step 200, a first storage module within the personal video recorder is associated with a specific content provider. In this manner, the first storage module is dedicated to receive and store content only from the associated content provider. As the sole content provider to the first storage module, the associated content provider maintains control of managing what content is provided to the first storage module. In the step 210, the content provider determines specific content to be sent to the first storage module. The content provider can determine the specific content to be sent based on any determining criteria. In one embodiment, a user associated with the first storage device has input a set of user preferences, as managed by the Profile Manager described above, and the determination criteria uses the user preferences to provide content that best matches the user preferences.

In the step 220, the first storage module receives and stores the content sent by the content provider. In the step 230, the first storage module receives and stores metadata associated with the received content. As described in detail above, the metadata can be provided by a metadata provider. The metadata provider can be different than the content provider, or the metadata provider and the content provider can be one and the same. It is understood that while the method describes two separate steps for receiving the content and the associated metadata, the content and the metadata can be received concurrently, or the content and the metadata can be sent together, as when the content provider and the metadata provider are the same.

In the step 240, the received content and the received associated metadata, are managed by the personal video recorder using the Cache Manager, the Content Manager, and the ShowFlow Manager, as described in detail above. In the step 250, content is output to an output device using the Presentation Manager.

As described above, one or more of the plurality of storage modules can be removably coupled to the PVR such that each removably coupled storage module can be disconnected from the PVR. The detached storage module can be reconnected to another PVR different from the PVR from which the storage module was detached. Where authorization is required to access content stored on the storage module, authentication is performed such that a first personal video recorder currently connected to the storage module is granted access to the content on the storage module. The authorization process is performed for each encrypted content item downloaded onto the storage module. If the storage module is disconnected from the first personal video recorder and then reconnected to a second personal video recorder, then authentication is performed to grant the second personal video recorder access to the content on the storage module. If the storage module is subsequently reconnected to the first personal video recorder, re-authorization may not be required if the original authorization parameters are still valid. If the original authorization parameters are not valid, the first personal video recorder must be re-authorized to access the content on the storage module.

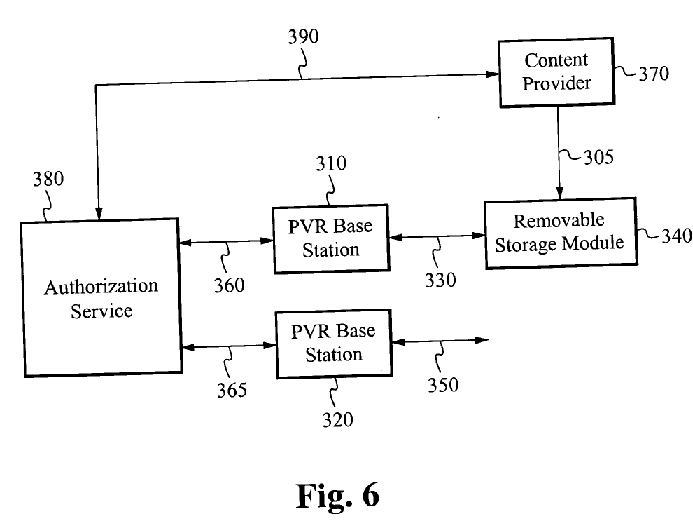

FIG. 6 illustrates a block diagram of a system used for authenticating content when the content stored on a removable media is moved from one PVR to another PVR. In the system of FIG. 6, the removable media is a removable storage module of the type described in detail above. A PVR base station 310 controls the acquisition, maintenance and display of content. PVR base station 310 is connected to removable storage module 340 via high-speed bus 330. Removable storage module 340 is comprised of a non-volatile storage such as a hard disk or flash memory, and a content receiver such as a programmable television tuner. Alternatively, the content receiver can reside within the PVR base station 310 instead of in the removable storage module 340. Content is received from a content provider 370 over network connection 305. Network connection 305 can be a satellite television, cable television, terrestrial television, Internet, or other transmission means.

Content that is transmitted from content provider 370 to the removable storage module 340 can be encrypted and as such, requires authorization before it can be viewed. If the content is encrypted when it is transmitted, then it is also stored in an encrypted form. The PVR base station 310 has a unique hardware identifier, such as a MAC (Medium Access Control) address from a network interface. In order to decode encrypted content, the PVR base station 310 sends its hardware identifier, and a unique content identifier received from the content provider to authorization service 380 over bidirectional network connection 360. Network connection 360 can be an intermittent connection, such as a phone line, that is only connected when needed.

For authorization, the PVR base station 310 can optionally also transmit to the authorization service user identification information when the PVR supports multiple users, additional authentication information to prove that the PVR or user identifier has not been tampered with, usage selection information such as view once, view for 24 hours, view without commercials, etc., and/or payment information such as credit card information or payment account information.

Authorization service 380 uses an authorization means to determine whether or not to grant PVR base station 310 authorization to access the requested content. The authorization service 380 can use additional information about the requesting PVR to make this decision. For example, the authorization service 380 can access a customer database to verify that the user's account is valid and paid. Or, the authorization service 380 can access a credit card authorization service to ensure that a credit card used for payment is valid. In some cases, authorization service 380 can perform accounting or other transactions with content provider 370 over network connection 390. In this case, network connection 390 is a secure network. In an alternate embodiment, authorization service 380 and content provider 370 are the same entity, and thus do not require network connection 390.

If authorization service 380 accepts the request, then authorization service 380 returns a key to PVR base station 310 over network connection 360. PVR base station 310 uses the key to decrypt content on removable storage module 340 and display the decrypted content to the user.

PVR base station 310 saves the authorization information used to decrypt the content. In one embodiment, the key is saved, along with additional metadata about the content, on the removable storage module 340. In this case, the hardware identifier corresponding to the PVR base station 310 is also saved with the key. Storing the authorization information on the same physical medium as the content and related descriptive metadata simplifies management of such information when content is subsequently deleted.

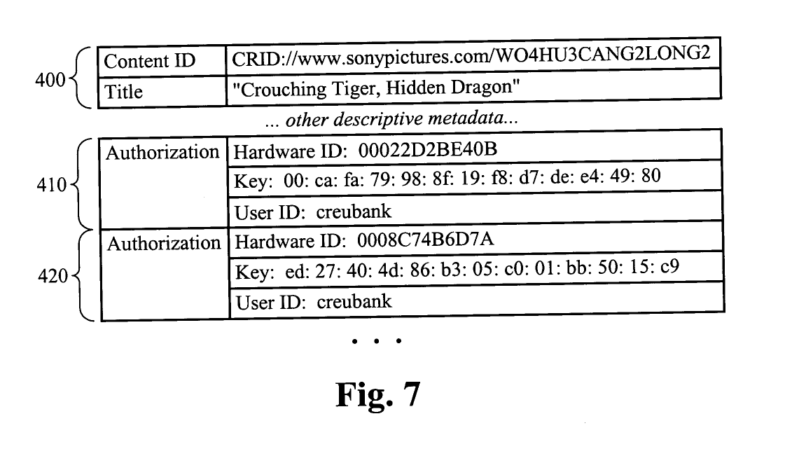

FIG. 7 illustrates an example of information about content that is stored on the removable storage module 340. Such information includes descriptive metadata 400, including a unique content identifier. The content identifier is sent along with the content by the content provider 370. Authorization information 410 and 420 includes the hardware identifier of the base station, the key to decrypt the encrypted content data, and, optionally, user identification information. As related to FIG. 6, authorization information 410 corresponds to PVR base station 310. As such, the hardware ID 00022D2BE40B shown in authorization information 410 is the unique hardware identifier of PVR base station 310.

Removable storage module 340 can be physically detached from bus 330 and connected to a second PVR base station 320 via a second bus 350. In this case, encrypted content that has not been authorized for viewing on PVR base station 320 must be re-authorized via the same process outlined above. The PVR base station 320 sends its unique hardware identifier to authorization service 380 over bi-directional network connection 365. Network connection 365 can be an intermittent connection, such as a phone line, that is only connected when needed. If authorization service 380 accepts the authorization request from the second PVR base station 320, then the authorization service 380 returns a second key to PVR base station 320 over network connection 365. PVR base station 320 uses the second key to decrypt the encrypted content on removable storage module 340 and displays the decrypted content to the user.

PVR base station 320 saves the authorization information used to decrypt the content. In one embodiment, the key is saved along with additional metadata about the content on the removable storage module 340. In this case, the hardware identifier corresponding to the PVR base station 320 is also saved with the key. Authorization information 420 (FIG. 7) corresponds to PVR base station 320. As such, the hardware ID 0008C74B6D7A shown in authorization information 420 is the unique hardware identifier of PVR base station 320.

Authorization information, such as authorization information 410 and 420, can alternatively be stored on the PVR base station for which authorization is granted, instead of on the removable storage module 340. Such an implementation makes it more difficult to manage authorization content, but obviates the need to include the hardware identifier in the authorization information.

Some content can be stored in a non-encrypted format. For example, free-to-air content that is covered by fair-use laws can be stored without encryption. If such an option is implemented, then the system uses an encryption identification means to determine whether or not the content is encrypted.

The system can support a plurality of encryption schemes. In this case, an encryption scheme identification means is used to determine what encryption scheme is being used. Such a system is useful when content can be transmitted via a plurality of transport means (Internet, satellite, digital terrestrial television).

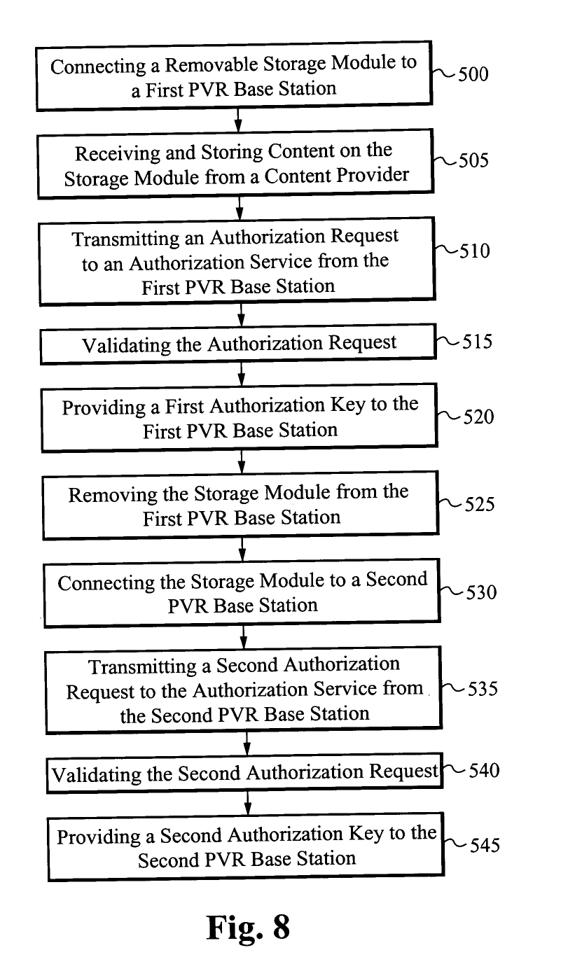

FIG. 8 illustrates a method of authenticating content on a removable storage module when the removable storage module is moved from one PVR to another PVR. The method illustrated in FIG. 8 is described in relation to the system of FIG. 6. In the step 500, the removable storage module 340 is connected to the first PVR base station 310. In the step 505, encrypted content is received by and stored on the storage module 340. The content is provided by the content provider 370. In the step 510, an authorization request is transmitted to the authorization service 380 from the first PVR base station 310. The authorization request is of the type described above and includes a content identification associated with the content stored on the storage module and a unique hardware identification associated with the first PVR base station 310. At the step 515, the authorization request is validated by the authorization service 380.

At the step 520, a first authorization key is provided by the authorization service 380 to the first PVR base station 310. The first authorization key associates the content on the storage module 340 to the first PVR base station 310. The first PVR base station 310 uses the authorization key to decrypt the encrypted content stored on the storage module 340.

At the step 525, the storage module 340 is removed, or disconnected, from the first PVR base station 310. At the step 530, the storage module 340 is connected to the second PVR base station 320. To access the encrypted content stored on the storage module 340, the second PVR base station 320 must receive authorization in a manner similar to that described above in relation to the first PVR base station 310 receiving authorization. At the step 535, a second authorization request is transmitted to the authorization service 380 from the second PVR base station 320. The second authorization request is of the type described above and includes the content identification associated with the content stored on the storage module and a second unique hardware identification associated with the second PVR base station 320. At the step 540, the second authorization request is validated by the authorization service 380.

At the step 545, a second authorization key is provided by the authorization service 380 to the second PVR base station 320. The second authorization key associates the content on the storage module 340 to the second PVR base station 320. The second PVR base station 320 uses the authorization key to decrypt the encrypted content stored on the storage module 340.

If the storage module 340 is disconnected from the second PVR base station 320 and connected to a third PVR base station, then the third PVR base station would request and receive authorization to access the content stored on the storage module in a manner similar to that described above in relation to the first PVR base station 310 and the second PVR base station 320. In this manner, the removable storage module 340 can be connected to any number of PVR base stations, and authorization can be requested and granted to access content on the storage module by any newly connected PVR base station.

If the removable storage module 340 is re-connected to a previously connected and authorized PVR base station, such as connecting the storage module 340 to the first PVR base station 310 subsequent to the step 545, then the previously authorized PVR base station can use the previously granted authorization key to access the content on the storage module 340. In this case, any requirements associated with the previously granted authorization key must still apply. For example, the previously granted first authorization key, which associates the content to the first PVR base station 310, can include a time period for which the first authorization key remains valid. Upon re-connecting the storage module 340 to the first PVR base station 310, the first PVR base station 310 can use the first authorization key to access the content if the time period has not yet elapsed. If the time period has elapsed, then the first PVR base station 310 must again go through the authorization process to receive a new valid authorization key.

In operation, a personal video reorder including one or more removable storage modules receives content from a content provider. Each storage module is dedicated to a single content provider such that the content provided by a first content provider is received and stored by a first storage module. Metadata associated with the content is sent either by a separate metadata provider or by the content provider. The content metadata is stored along with the content on the corresponding dedicated storage module. Selection of content to be sent to the storage module is managed by the content provider. User preferences are maintained and are used by the content provider to select the content to be sent. Content stored on the storage module is output by the personal video recorder to an output device, such as a television.

Some or all of the content provided by the content provider may be encrypted and require authorization to be viewed. In this case, the encrypted content sent by the first content provider is received by the personal video recorder and stored on the first storage module connected to the personal video recorder, as described above. To output the received encrypted content, the personal video recorder must decrypt the encrypted content stored on the first storage module. To decrypt the encrypted content, the personal video recorder transmits an authorization request to an external authorization service, which may or may not be the same entity as the first content provider. The authorization service validates the authorization request and transmits a first authorization key to the first personal recorder. The first personal video recorder uses the first authorization key to decrypt and output the encrypted content stored on the first storage module.

Since the first storage module is removable, the first storage module can be moved from the first personal video recorder to a second personal video recorder. In order for the second personal video recorder to decrypt and output the encrypted content stored on the first storage module, the second personal video recorder must receive authorization from the authorization service in a similar manner as that described above. The second personal video recorder transmits a second authorization request to the authorization service. The authorization service validates the second authorization request and sends a second authorization key to the second person video recorder. The second personal video recorder uses the second authorization key to decrypt and output the encrypted content stored on the first storage module. The removable storage module can be connected to any number of personal video recorders to output the stored encrypted content in this manner.

The present invention has been described in terms of specific embodiments incorporating details to facilitate the understanding of principles of construction and operation of the invention. Such reference herein to specific embodiments and details thereof is not intended to limit the scope of the claims appended hereto. It will be apparent to those skilled in the art that modifications may be made in the embodiment chosen for illustration without departing from the spirit and scope of the invention.

We claim:

1. A system to provide content, the system comprising:
a. a plurality of content sources, each content source providing one or more content data; and
b. a controller apparatus including a plurality of storage modules, each storage module dedicated to a select one of the plurality of content sources.

2. The system according to claim 1 wherein the controller apparatus includes a control device.

3. The system according to claim 2 wherein the control device is external to the plurality of storage modules.

4. The system according to claim 2 wherein the control apparatus is an integrated device including the control device and the plurality of storage modules.

5. The system according to claim 1 wherein each content data includes associated content metadata.

6. The system according to claim 5 wherein the metadata is provided by one or more metadata sources.

7. The system according to claim 6 wherein one or more of the plurality of content sources are a metadata source.

8. The system according to claim 6 wherein one or more of the plurality of content sources are not a metadata source.

9. The system according to claim 1 wherein each storage module receives content data independent of each of the plurality of storage modules.

10. The system according to claim 9 wherein more than one of the plurality of storage modules concurrently receive content data.

11. The system according to claim 1 wherein each storage module includes a receiver and a storage medium.

12. The system according to claim 1 wherein content data comprises multimedia data.

13. The system according to claim 1 wherein the controller apparatus is coupled to one or more network connections to receive the one or more content data and associated metadata.

14. The system according to claim 13 wherein each of the one or more network connections consists of a terrestrial, satellite, cable, or internet network connection.

15. The system according to claim 13 wherein one of the one or more network connections is a broadcast network.

16. The system according to claim 13 wherein one of the one or more network connections is a two-way network.

17. The system according to claim 1 further comprising an output device coupled to the controller apparatus to receive and output content data.

18. The system according to claim 1 wherein the controller apparatus includes a content manager to acquire content data based on associated metadata and stored user preferences.

19. The system according to claim 18 wherein the content manager enforces rights management rules.

20. A personal video recorder to receive content data, the personal video recorder comprising:
a. a plurality of storage modules, each storage module to receive content data from a select one of a plurality of content sources; and
b. a control device coupled to the plurality of storage modules to control receiving and outputting of the content data to and from the personal video recorder.

21. The personal video recorder according to claim 20 wherein each of the plurality of storage modules is removable from the personal video recorder.

22. The personal video recorder according to claim 20 wherein the control device and the plurality of storage modules are configured as an integrated device.

23. The personal video recorder according to claim 20 wherein each content data includes associated content metadata.

24. The personal video recorder according to claim 20 wherein each storage module receives content data independent of each of the plurality of storage modules.

25. The personal video recorder according to claim 24 wherein more than one of the plurality of storage modules concurrently receive content data.

26. The personal video recorder according to claim 20 wherein each storage module includes a receiver and a storage medium.

27. The personal video recorder according to claim 20 wherein content data comprises multimedia data.

28. The personal video recorder according to claim 20 further comprising one or more network connection ports to couple to one or more network connections to receive the content data and associated metadata.

29. The personal video recorder according to claim 28 wherein each of the one or more network connections consists of a terrestrial, satellite, cable, or internet network connection.

30. The personal video recorder according to claim 28 wherein one of the one or more network connections is a broadcast network.

31. The personal video recorder according to claim 28 wherein one of the one or more network connections is a two-way network.

32. The personal video recorder according to claim 20 further comprising an output port to provide content data to an output device.

33. The personal video recorder according to claim 20 further comprising a content manager to acquire content data based on associated metadata and stored user preferences.

34. The personal video recorder according to claim 33 wherein the content manager enforces rights management rules.

35. A method of providing content data, the method comprising:
a. providing a recording apparatus including a plurality of storage modules;
b. dedicating each one of the plurality of storage modules to receive content data from a select one of a plurality of content sources; and
c. receiving content data by one of the plurality of storage devices from the select one content source.

36. The method according to claim 35 further comprising associating metadata to each content data.

37. The method according to claim 36 further comprising controlling management of each one of the plurality of storage modules by the select one of the plurality of content sources.

38. The method according to claim 37 further comprising determining specific content data sent to one of the plurality of storage modules by the select one of the plurality of content sources.

39. The method according to claim 38 wherein determining specific content data utilizes predefined user preferences and the metadata.

40. The method according to claim 35 further comprising concurrently receiving content data by more than one of the plurality of storage devices.

41. The method according to claim 35 further comprising outputting content data from one of the plurality of content sources to an output device.
